(19) United States
(12) Patent Application Publication
(10) Pub. No.: US 2022/0262122 A1
(43) Pub. Date: Aug. 18, 2022

(54) IMAGE COLLECTION APPARATUS AND IMAGE COLLECTION METHOD

(71) Applicant: TOYOTA JIDOSHA KABUSHIKI KAISHA, Toyota-shi (JP)

(72) Inventors: Toshiki TAKI, Toyota-shi (JP); Yohei HAREYAMA, Ninomiya-machi (JP); Hiroyuki AMANO, Susono-shi (JP); Kazuyuki KAGAWA, Nagoya-shi (JP); Yuki TAKAHASHI, Susono-shi (JP)

(73) Assignee: TOYOTA JIDOSHA KABUSHIKI KAISHA, Toyota-shi (JP)

(21) Appl. No.: 17/554,660

(22) Filed: Dec. 17, 2021

(30) Foreign Application Priority Data
Feb. 16, 2021 (JP) 2021-022546

(51) Int. Cl. G06V 20/54; G06T 7/20

(52) U.S. Cl. CPC G06V 20/54; G06T 7/20; G06V 40/103; G06T 2207/30241; G06V 2201/08; G06T 2207/30236

(57) ABSTRACT

An image collection apparatus includes a processor configured to detect a moving object from an image obtained by a camera and representing a predetermined point or a predetermined vehicle surroundings, estimate a distance between another object and the moving object detected from the image, determine whether there is a risk of collision between the moving object and the other object based on the distance, and store the image in a memory when it is determined that there is the risk of collision.

### CROSS-REFERENCE TO RELATED APPLICATION

This application is based upon and claims the benefit of priority of the prior Japanese Patent Application No. 2021-022546, filed on Feb. 16, 2021, the entire contents of which are incorporated herein by reference.

### FIELD

The present disclosure relates to an image collection apparatus, an image collection method and a computer program for image collection for collecting an image representing a predetermined scene.

### BACKGROUND

A technique for appropriately collecting images representing a predetermined scene has been proposed (see, for example, Japanese Patent Application Laid-Open No. 2019-40368). In the technique disclosed in Japanese Patent Application Laid-Open No. 2019-40368, for each type of event that occurred at an intersection, an extraction condition of an image indicating the situation at the time of the occurrence of the event is stored. Then, according to event information including the type of the event input through an input unit, an image search key including the extraction condition of an image indicating the situation at the time of the occurrence of the event is generated. The generated image search key is transmitted to an investigation support apparatus that stores the captured images of the individual cameras installed at the plurality of intersections in association with the camera information and the intersection information.

### SUMMARY

In the above technique, in order to search for an image of a predetermined event which occurred at an intersection, it is required to input event information for specifying the predetermined event. Therefore, when a predetermined event such as a traffic accident is not actually occurring, it is difficult to utilize the above technique to collect images likely to be associated with the predetermined event.

It is therefore an object of preferred embodiments of the present disclosure to provide an image collection apparatus capable of appropriately collecting an image in which there is a possibility that a scene to be noted with respect to traffic safety is represented.

According to one embodiment, an image collection apparatus is provided. The image collection apparatus includes: a processor configured to detect a moving object from an image obtained by a camera and representing a predetermined point or a predetermined vehicle surroundings, estimate a distance between another object and the moving object detected from the image, determine whether there is a risk of collision between the moving object and the other object based on the distance, and store the image in a memory when it is determined that there is the risk of collision.

In the image collection apparatus, it is preferable that the processor determines that the risk is present when the distance is less than or equal to a predetermined distance threshold.

Alternatively, in the image collection apparatus, it is preferable that the processor tracks the moving object by associating the moving object with the moving object represented in a past image obtained by the camera earlier than the current image, predicts a trajectory through which the moving object passes based on the tracking result of the moving object, and determines that the risk is present when a distance between the moving object and the other object at any position on the predicted trajectory is equal to or less than a second threshold smaller than the predetermined distance threshold.

In addition, in the image collection apparatus, it is preferable that the processor stores in the memory a time series of images obtained by the camera within a predetermined period from the time when the image for which it is determined that the risk is present is obtained.

In this case, it is preferable that the processor further detects, within the predetermined period, that the moving object has collided with the other object, or that the moving object has performed a behavior to avoid collision with the other object, and the processor stores, in the memory, information identifying an image when the moving object collides with the other object or when the moving object performs the behavior, among the time series of images, together with the time series of images.

According to another embodiment, an image collection method is provided. The image collection method includes: detecting a moving object from an image obtained by a camera and representing a predetermined point or a predetermined vehicle surroundings; estimating a distance between another object and the moving object detected from the image; determining whether there is a risk of collision between the moving object and the other object based on the distance; and storing the image in a memory when it is determined that there is the risk of collision.

According to still another embodiment, a non-transitory recording medium having recorded thereon a computer program for image collection is provided. The computer program includes instructions for causing a computer to execute a process including: detecting a moving object from an image obtained by a camera and representing a predetermined point or a predetermined vehicle surroundings; estimating a distance between another object and the moving object detected from the image; determining whether there is a risk of collision between the moving object and the other object based on the distance; and storing the image in a memory when it is determined that there is the risk of collision.

The image collection apparatus according to preferred embodiments of the present disclosure has the effect that an image in which there is a possibility that a scene to be noted with respect to traffic safety is represented can be appropriately collected.

### BRIEF DESCRIPTION OF DRAWINGS

FIG. 1 is a schematic configuration diagram of an image collection system including an image collection apparatus.

FIG. 2 is a hardware configuration diagram of a server that is an example of an image collection apparatus.

FIG. 3 is a functional block diagram of a processor of the server associated with the image collection process.

FIG. 4A is a diagram for explaining an outline of determination as to whether or not an image is a caution image.

FIG. 4B is a diagram for explaining an outline of determination as to whether or not an image is a caution image.

FIG. 5 is an operation flowchart of the image collection process.

### DESCRIPTION OF EMBODIMENTS

Hereinafter, an image collection apparatus, an image collection method and an image collection computer program executed by the image collection apparatus will be described with reference to the drawings. The image collection apparatus detects one or more objects to be detected (e.g., vehicle, pedestrians, etc.) from an image of a predetermined point generated by the camera installed to photograph the point. The image collection apparatus determines whether or not there is a risk of collision between a moving object and another object based on the distance between the detected moving object and the other object. When it is determined that there is a risk of collision between the moving object and the other object, the image collection apparatus stores the image in a storage device as a caution image in which there is a possibility that a scene to be cautioned with respect to traffic safety, such as a possibility that a collision accident may occur, is represented. As a result, the image collection apparatus can appropriately collect a caution image.

The individual caution images collected by the image collection apparatus according to the present embodiment are used as individual data included in so-called big data in the technical field relating to AI or artificial intelligence. For example, the collected individual caution images are used as teaching data for teaching a classifier based on machine learning or deep learning for determining whether or not a dangerous situation such as an accident is likely to occur by inputting an image. Such a classifier may be configured based on a so-called neural network, but is not limited thereto, and may also be configured based on other machine learning systems.

Additionally, a classifier which has been taught using caution images collected by the image collection apparatus in accordance with the present embodiment may be utilized, for example, in a vehicle to which an automated driving control is applied, or in a road management system.

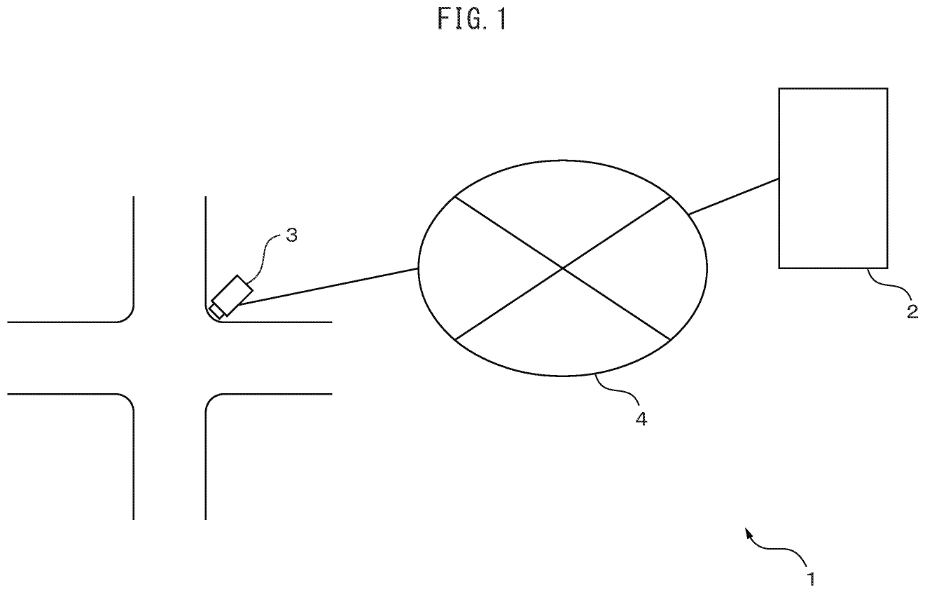

FIG. 1 is a schematic configuration diagram of an image collection system including an image collection apparatus. In the present embodiment, the image collection system 1 includes a server 2, which is an example of an image collection apparatus, and at least one camera 3. The camera 3 is used, for example, to observe a road in a smart city or a connected city that utilizes advanced technology such as big data. The camera 3 is installed to photograph a predetermined point such as an intersection, and is connected to a communication network 4 to which the server 2 is connected via a gateway or the like. Therefore, the camera 3 can communicate with the server 2 via the communication network 4. In FIG. 1, only one camera 3 is shown. However, the image collection system 1 may have a plurality of cameras 3.

The camera 3 is an example of an imaging unit and shoots a predetermined point for each predetermined shooting period to generate an image in which the predetermined point is represented. The camera 3 further includes a memory and temporarily stores the generated image in the memory. The camera 3 transmitted each stored image to the server 2 via the communication network 4 when the number of images stored in the memory reaches a predetermined number or when the amount of data of the image stored in the memory reaches a predetermined amount.

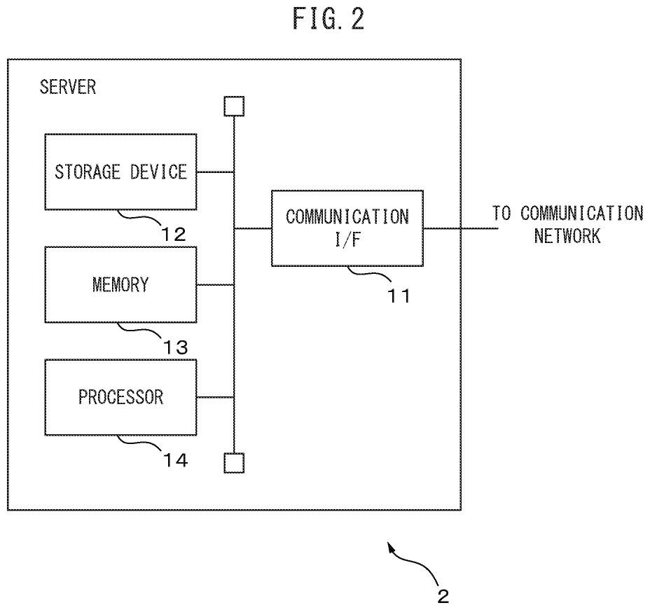

FIG. 2 is a hardware configuration diagram of the server 2 which is an example of an image collection apparatus. The server 2 includes a communication interface 11, a storage device 12, a memory 13, and a processor 14. The communication interface 11, the storage device 12, and the memory 13 are connected to the processor 14 via signal lines. The server 2 may further include an input device such as a keyboard and a mouse, and a display device such as a liquid crystal display.

The communication interface 11 is an example of a communication unit, and includes an interface circuit for connecting the server 2 to the communication network 4. That is, the communication interface 11 is configured to be able to communicate with the camera 3 through the communication network 4. The communication interface 11 passes the image received from the camera 3 via the communication network 4 to the processor 14.

The storage device 12 is an example of a storage unit, and includes, for example, a hard disk device, an optical recording medium, and an access device thereof. The storage device 12 stores the image received from the camera 3 and so on. Further, the storage device 12 may store a computer program running on the processor 14 for performing image collection processing.

The memory 13 is another example of the storage unit, and includes, for example, a nonvolatile semiconductor memory and a volatile semiconductor memory. The memory 13 stores various types of information used in the image collection process, for example, a distance threshold value, a parameter set for specifying a classifier used for detecting a moving object represented in an image, a focal length, an optical axis direction and an installation height of the camera 3, and the like. Further, the memory 13 temporarily stores images received from the camera 3 and various data generated during the execution of the image collection process.

The processor 14 is an example of a control unit, and includes one or a plurality of CPUs (Central Processing Unit) and peripheral circuits thereof. The processor 14 may further include other arithmetic circuits, such as a logic unit, a numerical unit, or a graphics processing unit. Each time an image is received from the camera 3, the processor 14 executes an image collection process on the received image.

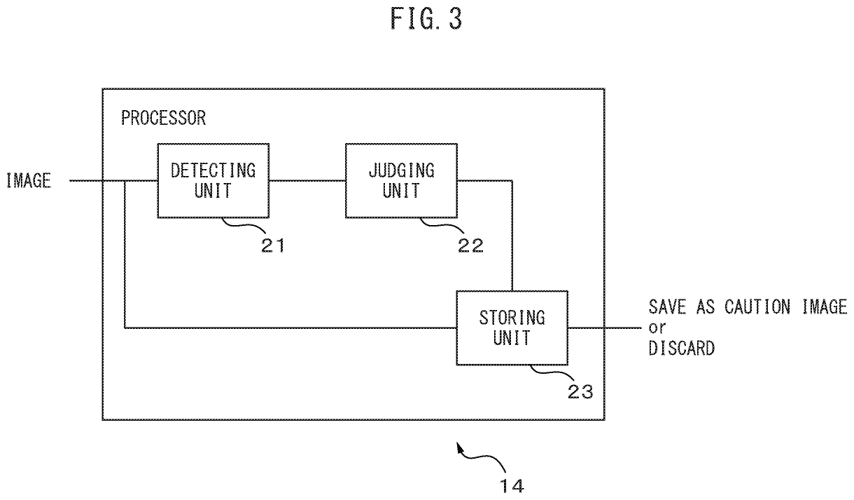

FIG. 3 is a functional block diagram of the processor 14 associated with the image collection process. The processor 14 includes a detecting unit 21, a judging unit 22, and a storing unit 23. Each of these units of the processor 14 is, for example, a functional module implemented by a computer program running on the processor 14. Alternatively, each of these units included in the processor 14 may be a dedicated arithmetic circuit provided in the processor 14.

The detecting unit 21 detects an object to be detected represented in an image. In the present embodiment, an object to be detected (hereinafter, sometimes simply referred to as an object or a target object) is a moving object that has a risk of causing a collision accident, and is, for example, a vehicle, a pedestrian, or the like.

The detecting unit 21 detects a target object represented in an image by, for example, inputting the image to a classifier. As such a classifier, the detecting unit 21 can use a deep neural network (DNN) having a convolutional neural network type (CNN) architecture such as Single Shot MultiBox Detector or Faster R-CNN. Alternatively, the detecting unit 21 may use a classifier based on another machine-learning technique, such as a AdaBoost classifier. Such a classifier is taught in advance so as to detect a target object from an image.

The classifier outputs information indicating a region in which the detected object is represented (hereinafter, referred to as an object region). For example, the classifier outputs a circumscribed rectangle surrounding the object region as such information. Therefore, the detecting unit 21 passes the information representing the object region for each of the detected objects to the judging unit 22.

The judging unit 22 estimates, for each object detected from the image received from the camera 3, the distance between the object and another object and determines whether or not there is a risk that the object collides with another object based on the estimated distance. When it is determined that there is a risk of colliding with another object for any of the objects detected from the image, the judging unit 22 judges the image as a caution image to be stored.

In the present embodiment, when the distance between any of the objects detected from the image and the other detected object is equal to or less than the predetermined distance threshold, the judging unit 22 determines that there is a risk that the object collides with the other object, and judges the image in which the object is represented as the caution image. Therefore, the judging unit 22 specifies, for each of the detected objects, the nearest other object based on the information representing the object region.

For each of the detected objects, the judging unit 22 estimates the distance between the object and the other object closest to the object based on the position of the object regions in which the objects are represented and the distance between the object regions. Since for each pixel on the image, the position of that pixel corresponds to an orientation as viewed from camera 3 on a 1-to-1 basis, the orientation to the object represented in that object region as viewed from the camera 3 is specified based on a predetermined position of the object region on the image (e.g., the position of the centroid of the object region). Furthermore, since the detected object is estimated to be located on the road surface, the judging unit 22 can estimate the position of the detected object in the real space based on the orientation to the object viewed from the camera 3, the focal length, the optical axis direction and the installation height of the camera 3. Therefore, the judging unit 22 may estimate the distance between the detected object and the other object closest to the object in the real space by estimating the positions of these objects based on the positions of the object regions in which the detected object and the other object closest to the detected object are represented on the image, the focal length, the optical axis direction, and the installation height of the camera 3.

When for each of the detected objects, the judging unit 22 estimates a distance between the object and the other object closest to the object, the judging unit 22 specifies a set of objects for which the estimated value of the distance is minimum. Then, the judging unit 22 compares the estimated value of the distance between the objects for the specified set of objects with the threshold value. When the estimated value of the distance is equal to or less than the threshold value, the judging unit 22 determines that there is a risk that the objects included in the specified set collide with each other, and determines the image in which the objects are represented to be a caution image.

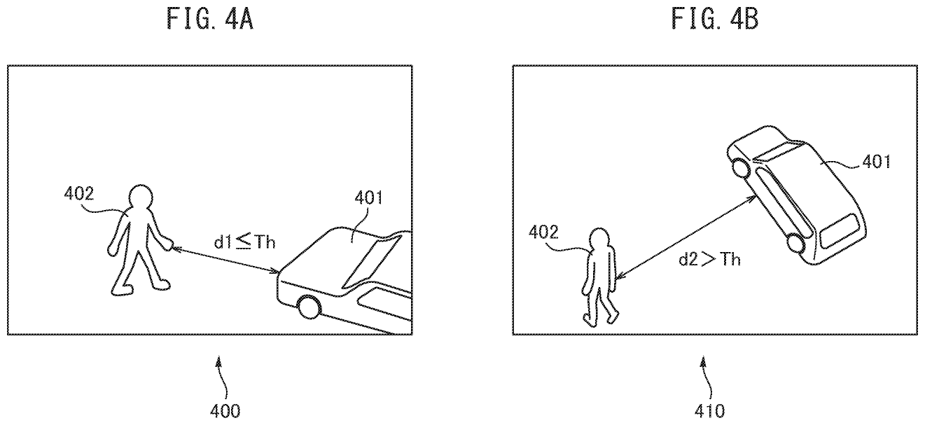

FIGS. 4A and 4B are diagrams for explaining the outline of determination as to whether or not an image is a caution image, respectively. Vehicle 401 and Pedestrian 402 are detected from image 400 shown in the FIG. 4A and image 410 shown in FIG. 4B, respectively.

In the example shown in FIG. 4A, the distance d1 between the vehicle 401 and the pedestrian 402 is equal to or less than a predetermined distance threshold Th. Therefore, the judging unit 22 determines that there is a risk that the vehicle 401 and the pedestrian 402 collide, and determines the image 400 as a caution image. On the other hand, in the example shown in FIG. 4B, the distance d2 between the vehicle 401 and the pedestrian 402 is greater than the predetermined distance threshold Th. Therefore, the judging unit 22 determines that there is no risk of collision between the vehicle 401 and the pedestrian 402 at the time when the image 410 is generated, and determines that the image 410 is not a caution image.

According to a modified example, the judging unit 22 compares the minimum value of the distance between the object regions on the image with a predetermined distance threshold value, and when the minimum value is equal to or less than the predetermined distance threshold value, the judging unit 22 may determine the image as a caution image. In this case, the judging unit 22 can reduce the calculation amount required for estimating the distance between the detected objects.

According to another modification, the judging unit 22 may track the moving object detected from the latest image by associating it with the moving object detected from the image obtained in the past by the camera 3, and predict the trajectory through which the moving object passes based on the tracking result. The judging unit 22 may determine that, for any of the moving objects, there is a risk that the object collides with another object being tracked when there is a point in time at which the distance between the position on the predicted trajectory (hereinafter, sometimes referred to as the predicted position) and the predicted position of the other object being tracked is equal to or less than a second threshold. The second threshold is smaller than the predetermined threshold.

In this case, the judging unit 22 tracks the object represented in the object region by applying the tracking process based on the optical flow, such as Lucas-Kanade method, to the object region of interest in the latest image obtained by the camera 3 and the object region in the previous image. In this case, for example, the judging unit 22 extracts a plurality of feature points from the object region of interest by applying filters for extracting feature points, such as a SIFT or a Harris operator, to the object region. Then, the judging unit 22 may calculate the optical flow by specifying, for each of the plurality of feature points, a corresponding point in the object region in the past image according to the applied tracking method. Alternatively, the judging unit 22 may track the object represented in the object region by applying another tracking method applied to the tracking of the moving object detected from an image to the object region of interest in the latest image and the object region in the past image.

The judging unit 22 performs viewpoint conversion processing for each object being tracked using information such as the optical axis direction, the focal length, and the installation height of the camera 3, thereby converting the coordinates in the image of the object into coordinates (bird's-eye coordinates) on the bird's-eye image. Then, the judging unit 22 can estimate the predicted trajectory of the object up to a predetermined time-ahead by performing a prediction process using a Kalman Filter, a Particle filter, or the like on the bird's-eye coordinates obtained from a series of images obtained during tracking.

The judging unit 22 may determine, for each tracked object, the minimum value of the distance between the predicted position of the object and the predicted position of the other tracked object by obtaining the distance between the predicted position of the object at each time point up to a predetermined time point and the predicted position of the other tracked object. Then, the judging unit 22 may determine, for each tracked object, whether there is a risk of colliding with another tracked object, by comparing the minimum value with the second distance threshold value.

According to still another modification, the judging unit 22 may change the distance threshold to be applied in accordance with the position of the detected object in the real space, or may exclude the detected object itself from the determination target of the risk of collision. For example, when the detected object is a pedestrian and the position of the pedestrian is on the sidewalk, the judging unit 22 may not determine the presence or absence of the risk of collision based on the distance to the other pedestrians. Further, when the detected object is a vehicle, the judging unit 22 may make the distance threshold that is compared with the distance between the vehicle and another vehicle traveling in a lane adjacent to the lane in which the vehicle travels smaller than the distance threshold that is compared with the distance between the vehicle and the pedestrian. In the present embodiment, since the camera 3 is fixedly installed, the position on the image with respect to the sidewalk, each lane, and the like in the real space is known. Therefore, a reference map indicating a position on an image such as a sidewalk, each lane, or the like may be stored in advance in the memory 13. The judging unit 22 can specify the position of the detected object in the real space by referring to the reference map and the position of the detected object on the image. The applied distance threshold value may be stored in advance in the memory 13 for each position in the real space. Furthermore, the judging unit 22 may change the distance threshold to be applied in accordance with the lighting state of the traffic light provided at a predetermined point at the timing when the camera 3 captures the point. For example, when the traffic light is a red signal, the vehicle stops in front of the intersection. Therefore, even if a pedestrian passes in front of the vehicle, there is no risk of collision between the vehicle and the pedestrian. Hence, the judging unit 22 may make the distance threshold to be applied when the lighting state of the signal is a red signal smaller than the distance threshold to be applied when the lighting state of the signal is a green signal. Incidentally, the judging unit 22 calculates the average value of the colors of the areas where the traffic light is represented on the image, and compares the average value with the range of the colors set in advance for each light state of the traffic light. The judging unit 22 may determine the lighting state corresponding to the range in which the average value of the colors is included as the lighting state of the actual signal. Alternatively, the judging unit 22 may determine the lighting state of the traffic light according to another method of determining the lighting state of the traffic light from the image.

The judging unit 22 notifies the storing unit 23 of the determination result as to whether or not the image received from the camera 3 is a caution image.

The storing unit 23 stores the image received from the camera 3 in the storage device 12 when it receives from the judging unit 22 a determination result that the image is a caution image. At this time, the storing unit 23 may store the information indicating the object region including the object detected from the image and the type of the detected object in the storage device 12 together with the image. On the other hand, the storing unit 23 discards the image received from the camera 3 when it receives from the judging unit 22 a determination result that the image is not a caution image.

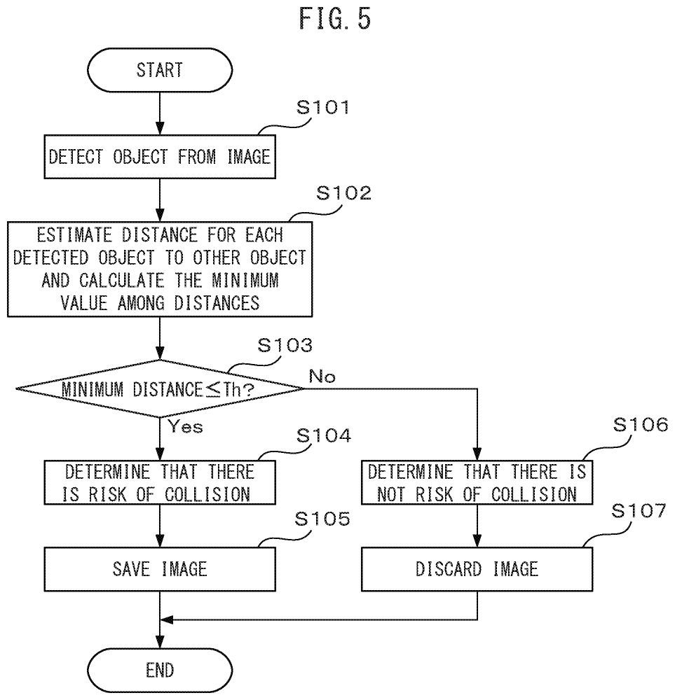

FIG. 5 is an operation flowchart of the image collection process. Each time an image is received from the camera 3, the processor 14 performs the image collection process on the received image in accordance with the following operation flowchart.

The detecting unit 21 of the processor 14 detects an object to be detected, which is represented in the image (step S101). The judging unit 22 of the processor 14 estimates, for each of the detected objects, the distances from the object to other objects, and obtains the smallest of the distances estimated for each object (step S102). Then, the judging unit 22 determines whether the minimum value of the distance is equal to or less than a predetermined distance threshold Th (step S103).

When the minimum value of the distance is equal to or less than the threshold Th (step S103—Yes), the judging unit 22 determines that there is a risk of collision with respect to the image received from the camera 3 (step S104). Then, the storing unit 23 of the processor 14 stores the image determined to be at risk of collisions in the storage device 12 as a caution image (step S105).

On the other hand, when the minimum value of the distance is larger than the threshold value Th (step S103—No), the judging unit 22 determines that there is no risk of collision with respect to the image received from the camera 3 (step S106). Then, the storing unit 23 discards the image (step S107). After the steps S105 or S107, the processor 14 terminates the image collection process.

As described above, the image collection apparatus detects one or more objects to be detected from an image of a predetermined point generated by the camera, and determines whether or not there is a risk that the object collides with another object based on the distance between the detected object and the other object. When it is determined that there is a risk of collision between the object and another object, the image collection apparatus stores the image in the storage apparatus as a caution image. As a result, the image collection apparatus can appropriately collect a caution image.

According to a modification, when the distance between the objects detected from the image obtained at a certain point in time becomes equal to or less than the predetermined distance threshold, the judging unit 22 may determine each of a time series of images obtained from the camera 3 during a predetermined period from the point in time as caution images. Then, the storing unit 23 may store a time series of caution images obtained in the predetermined period in the storage device 12. As a result, the image collecting apparatus can increase the possibility that the image when an accident occurs or when a vehicle or a pedestrian takes an emergency avoidance action even if the accident does not occur can be stored. Incidentally, the predetermined period may be a period of a preset length, or the judging unit 22 may terminate the predetermined period when the minimum value of the distance between the detected objects becomes larger than the predetermined distance threshold.

Further, the detecting unit 21 may detect that an accident has occurred or that an emergency avoidance action has been performed in the predetermined period (hereinafter, these are collectively referred to as a warning event for convenience of description). The storing unit 23 may store, together with a series of caution images, information identifying the image on which the warning event is detected and information indicating the object related to the warning event in the storage device 12.

In this case, when the distance between the two objects detected from the image is smaller than a contact determination threshold in any of the images during the predetermined period, the detecting unit 21 determines that a warning event has occurred in the image, and specifies the two objects as objects related to the warning event. The contact determination threshold is set to a value smaller than the predetermined distance threshold, for example, a value of about several tens of centimeters.

Alternatively, when detecting that the posture of an object whose distance to another object is equal to or less than the predetermined distance threshold in any image during the predetermined period is a specific posture, the detecting unit 21 may determine that a warning event has occurred. The specific posture can be, for example, a posture that lies on the road surface for a pedestrian, or a posture that is oriented across an extending direction of a road for a vehicle. In this case, the detecting unit 21 determines whether or not the posture of the object is the specific posture, for example, by inputting an object region including the target object to a classifier taught in advance so as to detect the posture of the object. The detecting unit 21 can use a DNN having a CNN-type architecture, such as DeepPose or HRNet, for example, as the classifier for the posture detection. Alternatively, the detecting unit 21 may determine whether or not the posture of the object is the specific posture based on the aspect ratio of the object region including the target object. For example, a pedestrian usually has a length in the vertical direction with respect to the road surface (hereinafter referred to as “height”) longer than a length in the horizontal direction parallel to the road surface (hereinafter referred to as “width”). However, when a pedestrian lies on the road surface, the width of the object region becomes longer than the height of the object region. Therefore, when the ratio of the height to the width of the object region including the object of interest is equal to or less than the predetermined ratio, the detecting unit 21 may determine that the posture of the object is the specific posture.

Alternatively, the detecting unit 21 may determine that a warning event has occurred when detecting that an object whose distance from another object is equal to or less than the predetermined distance threshold in any image in the predetermined period (hereinafter, referred to as a “target object”) has taken a behavior for avoiding collision. In this case, as described in the above-described embodiment, the detecting unit 21 obtains the trajectory of the object of interest in a certain period by tracking the object of interest, and determines whether or not the object of interest has taken a behavior for avoiding collision, based on the trajectory. For example, the detecting unit 21 may determine that the object of interest has taken a behavior for avoiding collision when the traveling direction of the object of interest changes by a predetermined angle or more, or when the deceleration of the object of interest becomes equal to or greater than a predetermined deceleration threshold.

When a set of a series of caution images is obtained by a predetermined number or more, the judging unit 22 may update the predetermined distance threshold used for determining whether an image obtained from the camera 3 is a caution image or not using the set of those caution images. For example, the judging unit 22 classifies each of the series of sets of caution images into a set in which a warning event has occurred and a set in which a warning event has not occurred. The judging unit 22 calculates an average value and a variance of the minimum values of the distances between the detected objects for each of the sets in which the warning event has occurred and the sets in which the warning event has not occurred. Then, based on the variances of the respective sets, the judging unit 22 may update the predetermined distance threshold by using a distance at which the Mahalanobis distance from the average value of the minimum values of the distances for the sets in which the warning event has occurred becomes equal to the Mahalanobis distance from the average value of the minimum values of the distances for the sets in which the warning event has not occurred. By updating the predetermined distance threshold in this manner, the image collection apparatus can more appropriately collect a caution image.

According to still another modification, the camera 3 may have a processor and a memory, and the processor of the camera 3 may execute the processing of the detecting unit 21, the judging unit 22, and the storing unit 23 according to the embodiment or the modification described above. In this case, the camera 3 itself is another example of the image collection apparatus. In this case, the processor of the camera 3 may transmit only the image determined to be the caution image among the images generated by the camera 3 to the server 2, and store the caution image in the storage device 12 of the server 2. According to this modification, since only the caution image is transmitted from the camera 3 to the server 2, the communication load is reduced.

The camera 3 may also be mounted in a vehicle, such as a two-wheeled vehicle, a normal vehicle, or a truck to photograph the perimeter of the vehicle. In this case, the camera 3 accesses a wireless base station (not shown) connected to the communication network 4 by radio communication, thereby being communicably connected to the server 2 via the radio base station and the communication network 4. In this case, when the distance between the vehicle to which the camera 3 is attached and the moving object detected from the image is equal to or less than the predetermined distance threshold, the judging unit 22 may determine that there is a risk of collision between the moving object and the vehicle, and may determine that the image is a caution image. In this case, the vehicle to which the camera 3 is attached is an example of another object.

The judging unit 22 may estimate the distance between the vehicle and the moving object based on the type of the moving object represented in the image and the size of the object region including the moving object on the image. In this case, the memory 13 stores in advance a reference table representing the relationship between the size on the image and the distance between the moving object and the vehicle for each type of moving object. Then, the judging unit 22 may estimate the distance between the vehicle and the moving object by referring to the reference table. Alternatively, since the position of the lower end of the moving object on the image is estimated to represent the position where the moving object is in contact with a road surface, the judging unit 22 may estimate the distance from the vehicle to the moving object based on the position of the lower end of the moving object on the image. In this case, the judging unit 22 can estimate the orientation to the position of the lower end of the moving object viewed from the camera 3 based on the position of the lower end of the moving object on the image, the optical axis direction and the focal length of the camera 3. Furthermore, the judging unit 22 can estimate the distance from the vehicle to the moving object based on the orientation to the position of the lower end of the moving object viewed from the camera 3 and the height from the road surface of the camera 3.

As described above, those skilled in the art can make various changes within the scope of the present disclosure in accordance with the embodiments to be implemented.

What is claimed is:

1. An image collection apparatus comprising:
a processor configured to:
detect a moving object from an image obtained by a camera and representing a predetermined point or a predetermined vehicle surroundings,
estimate a distance between another object and the moving object detected from the image,
determine whether there is a risk of collision between the moving object and the other object based on the distance, and
store the image in a memory when it is determined that there is the risk of collision.

2. The image collection apparatus according to claim 1, wherein the processor determines that the risk exists when the distance is less than or equal to a predetermined distance threshold.

3. The image collection apparatus according to claim 2, wherein the processor:
tracks the moving object by associating the moving object in a current image with the moving object represented in a past image obtained by the camera earlier than the current image,
predicts a trajectory through which the moving object passes based on a tracking result of the moving object, and
determines that the risk exists when the distance between the moving object and the other object at any position on the predicted trajectory is equal to or less than a second threshold that is smaller than the predetermined distance threshold.

4. The image collection apparatus according to claim 1, wherein the processor stores in the memory a time series of images obtained by the camera within a predetermined period from a time when the image for which it is determined that the risk exists is obtained.

5. The image collection apparatus according to claim 4, wherein the processor is further configured to detect, within the predetermined period, whether the moving object has collided with the other object, or that the moving object has performed a behavior to avoid collision with the other object, and
the processor stores, in the memory, information identifying an image when the moving object collides with the other object or when the moving object performs the behavior, among the time series of images, together with the time series of images.

6. An image collection method comprising:
detecting a moving object from an image obtained by a camera and representing a predetermined point or a predetermined vehicle surroundings;
estimating a distance between another object and the moving object detected from the image;
determining whether there is a risk of collision between the moving object and the other object based on the distance; and
storing the image in a memory when it is determined that there is the risk of collision.

7. A non-transitory recording medium having recorded thereon a computer program for image collection, the program causing a computer to execute a process comprising:
detecting a moving object from an image obtained by a camera and representing a predetermined point or a predetermined vehicle surroundings;
estimating a distance between another object and the moving object detected from the image;
determining whether there is a risk of collision between the moving object and the other object based on the distance; and
storing the image in a memory when it is determined that there is the risk of collision.
